(19) United States
(12) Patent Application Publication
(10) Pub. No.: US 2021/0332984 A1
(43) Pub. Date: Oct. 28, 2021

(54) FLUSHING MACHINE

(71) Applicant: ADEY HOLDINGS (2008) LIMITED, Cheltenham (GB)

(72) Inventors: Alan Pearcy, Dunfermline, Fife (GB); Simon Downie, Cheltenham Gloucestershire (GB)

(21) Appl. No.: 17/274,232

(22) PCT Filed: Aug. 29, 2019
(86) PCT No.: PCT/EP2019/073094

§ 371 Date: Mar. 8, 2021

(30) Foreign Application Priority Data
Sep. 7, 2018 (GB) 1814622.5

(51) Int. Cl. F24D 19/00; B08B 9/032

(52) U.S. Cl. CPC F24D 19/0092; B08B 2209/032; B08B 9/0325

(57) ABSTRACT

A flushing machine (10) comprises at least one magnetic filter (24a, 24b), a pump (26), and first and second connections (40a, 40b) for connecting to a central heating circuit (40) to (5) be flushed, and valve means (36, 38) enabling the flow direction through

The present invention relates to a flushing machine and particularly to a flushing machine for flushing and removing debris from a central heating or cooling system circuit.

### BACKGROUND TO THE INVENTION

It is known that black iron oxide, known as magnetite, can build up in circulated water central heating and cooling circuits and settle as sludge. In systems which are not well maintained with the use of magnetic filters and rust inhibitors in the system water, the sludge builds up in pipes, radiators and the heat exchanger, and there is a constant circulation of magnetite in the system. In hard water areas, there is also a tendency for limescale to accumulate in the heat exchanger of the boiler, reducing its efficiency. The sludge reduces the efficiency of the system by creating cold spots, reducing heat transfer leading to increasing warm up time, it increases noise in the system and can eventually lead to failure of the boiler and pump.

When servicing a poorly maintained system or fitting a new boiler to the system on breakdown, it is good practice to flush the system to try and remove the sludge and loosen limescale deposits in order to restore the system to its optimum operating condition. This is known as “power flushing, jet flushing or hard flushing”. Power flushing involves the connection of a pump to the system, which pumps water at a high velocity and pressure through the system, to loosen and mobilise corrosion and limescale deposits, and to suspend them in rapidly moving water. Sometimes, specialist cleansing chemicals are added to the water to improve the effectiveness of the cleaning process. Once loosened, the unwanted debris is purged from the system with the flow of clean water.

The disadvantage of power flushing is that it involves connection of a separate specialist and expensive pump to the central heating system. The pump flushes fresh water held in a tank through the system at a high flow rate and at significant pressure. Usually, individual radiators are purged one by one, and the cleaning process results in a high volume of waste or ‘spent’ water, which can typically amount to around 2,800 litres per power flush for a typical domestic heating circuit.

To mitigate this, it is known to flush a system by connecting an external powerful magnetic filter to the system and using the system pump to circulate water through the filter as described in granted patent GB 2480866 B. Agitation of the radiators can assist in loosening sludge deposits, thus increasing the effectiveness of the flush. However, care has to be taken when flushing in this way not to put undue load on the system pump, which is not designed for flushing. In some cases the pump may be inoperable or if a new pump/boiler is fitted, it is undesirable to flush because this can void a warranty.

It is an object of the invention to provide an improved flushing machine which reduce or substantially obviate the aforementioned problems.

### STATEMENT OF INVENTION

According to the present invention there is provided a flushing machine comprising at least one magnetic filter, a pump, and first and second connections for connecting to a central heating circuit to be flushed, and valve means enabling the flow direction through the first and second connections to be changed.

By enabling flow in both directions through a central heating system, flow can be directed in the opposite direction to the usual water flow direction, enhancing the flushing process.

The magnetic filter, pump and valve means may be connected to direct flow through the filter before the pump, irrespective of the direction of flow through the first and second connections. This prevents damage to the pump from magnetite contaminated water.

The valve means may include at least two 2-way valves. By using two 2-way valves, flow can be directed through the filters before the pump, irrespective of the output flow direction.

There may be two magnetic filters connected in series. Use of two magnetic filters in series reduces the filter size, for portability of the device. It also provides for more effective filtering.

A third valve and a connecting pipe may be provided enabling the first and second connections to be connected together. A shutoff valve may be provided to isolate the magnetic filter(s) and pump in a bypass mode. This enables testing of a central heating system, without disconnection.

A fourth valve may be provided for diverting an outlet flow from the filter(s) to a drain outlet. A connection may be provided for connecting to a mains water supply. A double check valve may be positioned adjacent the mains water connection for preventing backflow into the mains water supply.

The fourth valve may be utilised in a dump mode, where mains water is passed through the central heating circuit, through the filter(s) and directly to drain.

The or each valve may be electrically operated and a control unit may be provided for operation of the or each valve.

The or each valve may be operated automatically on selection of a mode of operation.

The direction of flow through the first and second connections may be changed automatically during a flush. It may oscillate.

A magnetite sensor may be provided on the filter(s). In a preferred arrangement, a magnetite sensor is provided on only the first filter in the flow path before the pump. This provides an early warning that the filtering capacity is nearly full and protects the pump further against risk of magnetite damage.

The control unit may automatically shut down the pump to stop flushing when the magnetite sensor detects a predetermined level of magnetite in the filter(s).

There is also provided a method of flushing using a flushing machine comprising passing flushing water through a central heating circuit in one direction and then in the other direction. The direction of flow may be changed back and fore automatically on a timer, during a flushing process.

Advantageously, the device and method use reduced water amounts for a flush compared with existing external power flushing devices. Furthermore, a lower powered pump can be utilised, because the change in flow direction facilitates sludge removal. The use of two magnetic filters also reduces their size. In this way a portable and inexpensive machine can be manufactured.

It should be noted that the flushing machine does not include a holding tank for holding flushing water. A major advantage of the flushing machine is the lack of water tank and the ability to use a relatively low powered pump facilitated by the magnetic capacity of the filters and the ability to change the direction of flushing flow.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a schematic flow diagram of a flushing machine of the invention with flow in a first direction, with water being supplied from a mains supply and dirty water being dumped;

FIG. 2 shows a schematic flow diagram of a flushing machine of the invention with flow in the first direction, with water being circulated;

FIG. 3 shows a schematic flow diagram of a flushing machine of the invention with flow in a second reverse direction, with water being supplied from a mains supply and dirty water being dumped;

FIG. 4 shows a schematic flow diagram of a flushing machine of the invention with flow in the second reverse direction, with water being circulated;

FIG. 5 shows a schematic flow diagram of a flushing machine of the invention with flow by-passing the pump and filter for testing of a connected system;

FIG. 6 shows an embodiment of a flushing machine of the invention in a position for use; and

FIG. 7 shows the flushing machine of FIG. 6 in a position for transit.

### DESCRIPTION OF PREFERRED EMBODIMENTS

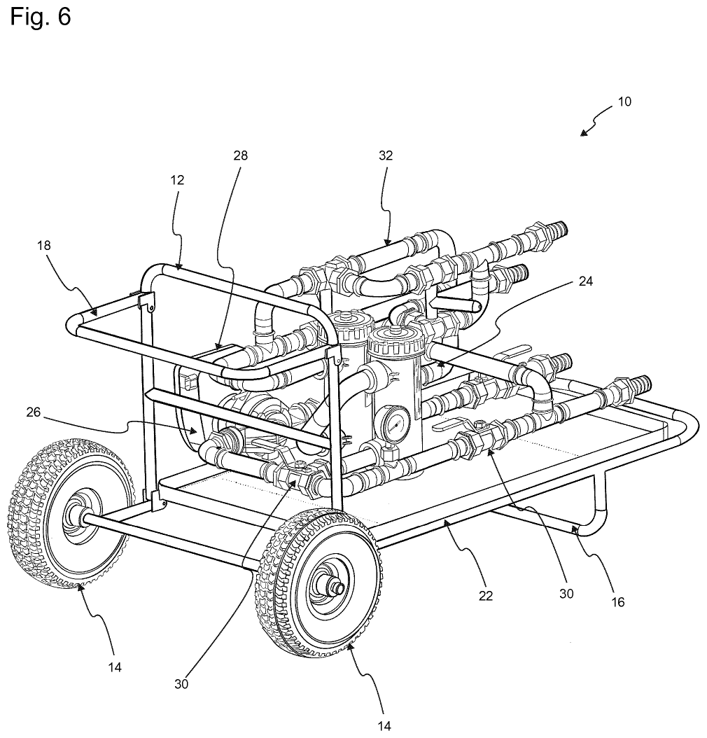

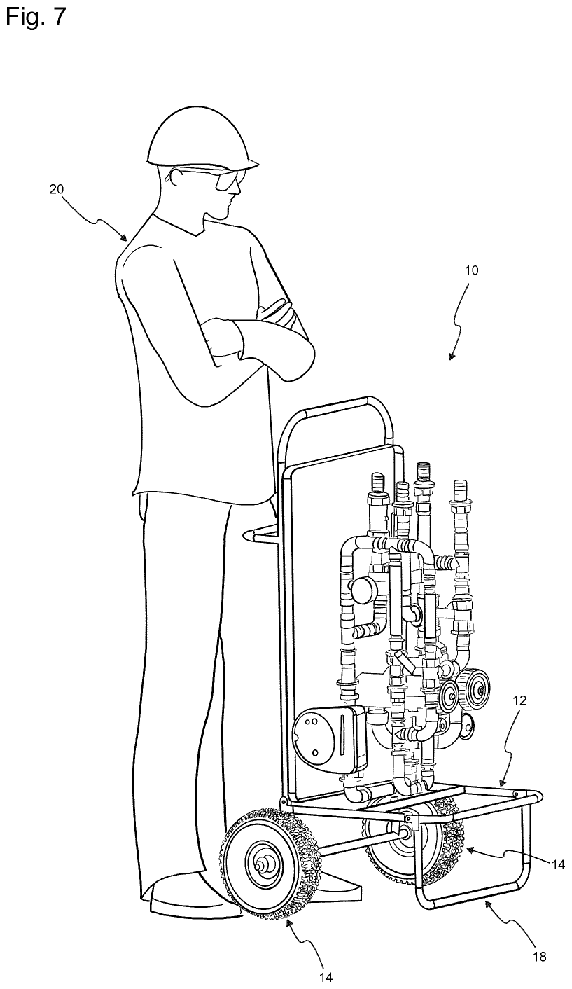

Referring firstly to FIGS. 6 and 7, a flushing machine is indicated generally at 10. The machine 10 comprises a frame/chassis 12 with a pair of wheels 14 mounted at one end. Support legs 16, 18 are provided on adjacent perpendicular faces of the frame 12 distant from the wheels 14, enabling the machine to be positioned in different orientations. The machine can be positioned in a first orientation for use, as shown in FIG. 6, supported by the wheels 14 and support leg 16, and in a second orientation for transit, as shown in FIG. 7, supported by the wheels 14 and support leg 18. To move the machine 10, a person, indicated at 20, can pivot the machine off the support leg 18 onto the wheels 14 and wheel it in the manner of a sack truck, using the frame 12 as a handle.

A drip tray 22 is mounted to the frame 12, which catches any drips from the machine in operation, when positioned as shown in FIG. 6.

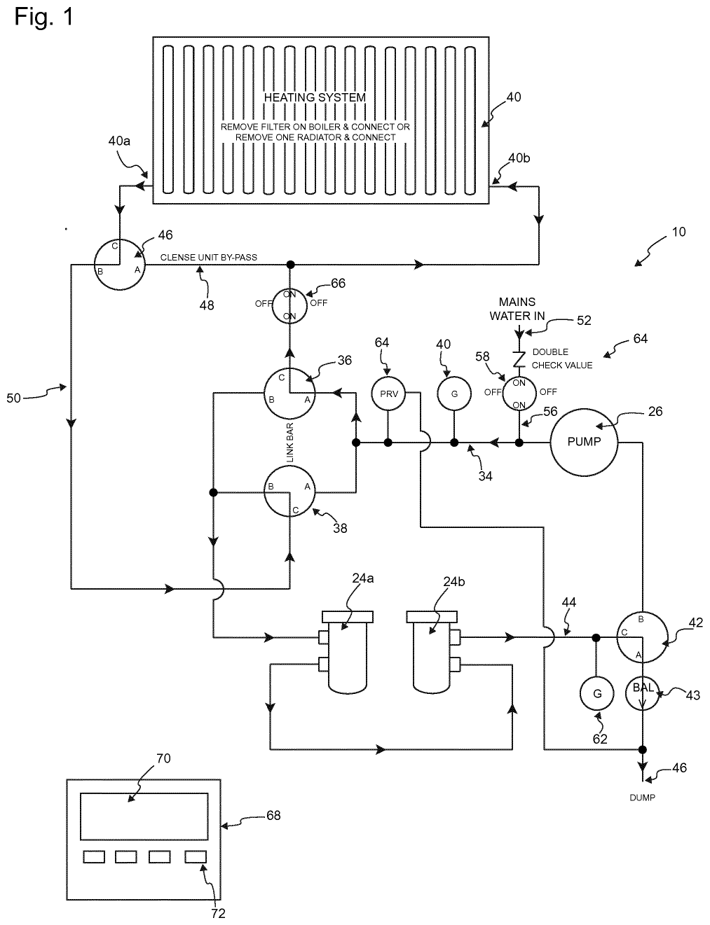

The flushing components of the machine 10, mounted on the drip dray, include a magnetic filter arrangement 24, a pump 26 including a drive motor 28, a plurality of valves 30 and connecting pipework 32. The arrangement of the flushing components will now be described in more detail with reference to FIGS. 1 to 5.

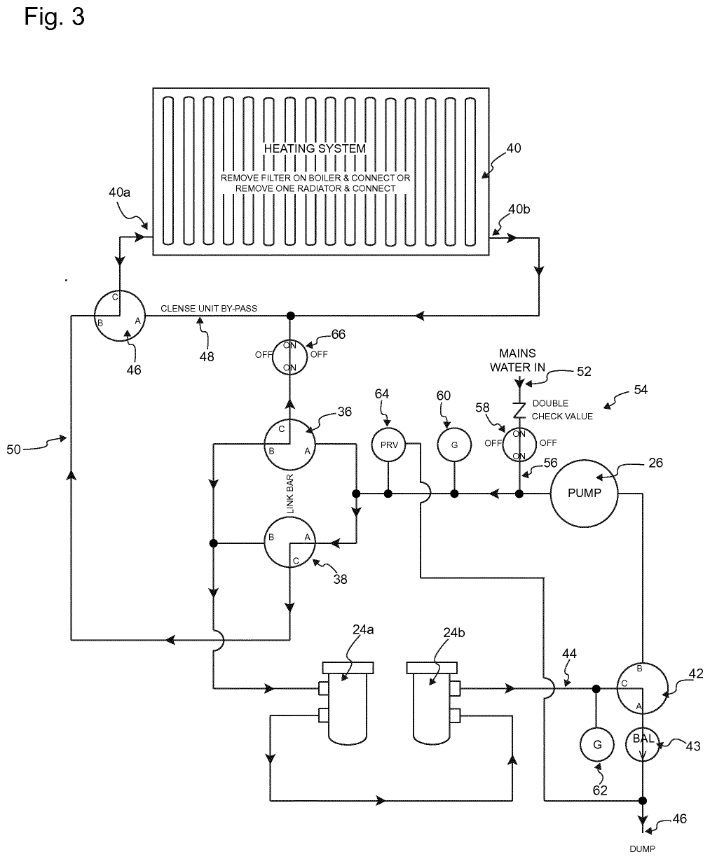

Referring specifically to FIGS. 1 and 3, the pipework 32 and components will now be described in more detail. The pump 26 is connected to pump directly through a pipe 34 to inlets of first and second 2-way valves 36, 38. These valves may be mounted on a bar and operated in unison. The purpose of the valves 36, 38 is to direct the flow from the pump 26 to a central heating circuit to be flushed, indicated by radiator 40, in different flow directions. The central heating circuit 40 is connected across connection points 40a, 40b.

The central heating circuit 40 can be connected by removing a system filter and utilising the filter connections, or by removing a radiator and connecting across the radiator connections.

The magnetic filter arrangement 24 includes a pair of magnetic filters 24a, 24b, which are connected in series. Two magnetic filters are preferred to provide sufficient filtering capacity, but a single filter could be provided. The magnetic filters 24a, 24b always outlet in a direction towards the pump 26, so that filtered water passes through the pump, when in circulation mode. This protects the pump 26 from damage from particles in suspension in the water.

A third 2-way valve 42 is positioned in a pipe 44, between the second filter 24b and the pump 26. This valve 42 can be arranged to direct flow directly to an outlet 46 for dumping, ie draining away, or circulating back through pump 26. A balancing valve 43 is provided in the pipe between the valve 42 and the dump outlet for controlling the rate of flow to dump.

A fourth 2-way valve 46 is connected between the central heating connection points 40a, 40b by a link pipe 48, but otherwise sits in a pipe 50 between the valve 38 and the connection point 40a. The purpose of the valve 46 is to provide a by-pass for the flushing unit, to enable a system to be tested, whilst the flushing unit is still attached. An on/off valve 66 is positioned in the pipe between the valve 36 and the pipe 50 (connected to the valve 46 and connection 40b), which shuts off the circuit when the device is in bypass mode.

An inlet for mains water to the machine 10 is provided at 52 and is protected by a double check valve 54, which prevents dirty water from passing back to the mains supply. The inlet 52 is positioned on an inlet pipe 56, which connects to the circuit between the pump 26 and the valves 36, 38. An on/off valve 58 is also positioned in the line 56.

Two pressure gauges 60,62 are provided in the circuit and serve to monitor the pressure either side of the pump 26. The first pressure gauge 60 is positioned between the pump 26 and the valves 36, 38. It is also positioned after the mains water inlet 52, and so can measure the mains inlet pressure to the circuit. The second gauge 62 is positioned between the filter 24b and the valve 42. It can measure the pressure before the pump 26 when the system is circulating, but measure the low pressure before the dump outlet 46 also.

A pressure relief valve 64 is provided between the pump 26 and valves 36,38. This is connected directly to the dump outlet 46.

The operation of the device will now be described. Referring firstly to FIG. 1, the device 10 is shown in a mains water flushing mode. Mains water from the inlet 52 passes to the valves 36, 38 and is directed through ports A-C on valve 36 to connection 40b on the central heating circuit 40. Once the water has passed through the central heating circuit 40 to be flushed, the water passes through connection 40a and is routed through valve 46 through ports C-B. The flow passes back to the valve arrangement, where it passes through ports C-B of valve 38 to the filters 24a, 24b, where the water is magnetically filtered. After filtering, the water is passed through ports C-A of valve 42 to dump. The dump rate is controlled by balancing valve 43, which ensures that sufficient water is retained in the central heating circuit 40 for effective flushing.

Referring now to FIG. 3, the device 10 is shown again in a mains water flushing mode, but with the flow direction reversed through the central heating circuit 40. Mains water from the inlet 52 passes to the valves 36, 38 and is directed through ports A-C on valve 38, through ports B-C on valve 46 to connection 40a on the central heating circuit 40. Once the water has passed through the central heating circuit 40 to be flushed, the water passes through connection 40b and passes back to the valve arrangement, where it passes through ports C-B of valve 36. This directs the water to the filters 24a, 24b, where the water is magnetically filtered. After filtering, the water is again passed through ports C-A of valve 42 to dump.

In a mains water flushing mode of operation, the pump is switched off and is isolated from the water flow by the valves, particularly the closure of port B, on valve 42. It will be noted that the water does pass through the filters before being dumped to prevent contamination of the drain water, and therefore, the filters 24a, 24b need to be monitored and cleaned when in dumping mode.

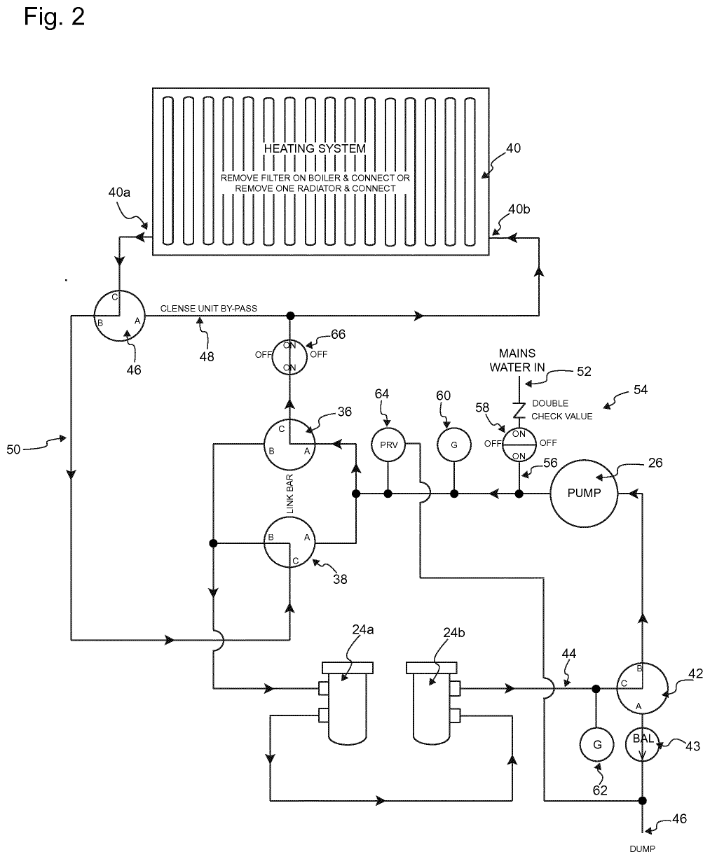

Referring now to FIG. 2, the device 10 is shown in a flushing mode with water being circulated by the pump 26 through the central heating circuit 40 and filters 24a, 24b. The system can be filled through the mains water inlet 52 to a desired pressure, monitored on the pressure gauge 60 and the valve 58 can then be turned off to cut off the water supply. The water is pumped by the pump 26 to the filter arrangement though ports A-C of valve 36 to connection 40b of the central heating circuit 40. Once the water has passed through the central heating circuit 40 to be flushed, the water passes through connection 40a and is routed through valve 46 through ports C-B. The flow passes back to the valve arrangement, where it passes through ports C-B of valve 38 to the filters 24a, 24b, where the water is magnetically filtered. After filtering, the water is passed through ports C-B of valve 42 and is directed back to the pump 26. In other words, clean water, having been filtered, is passed back to the pump 26.

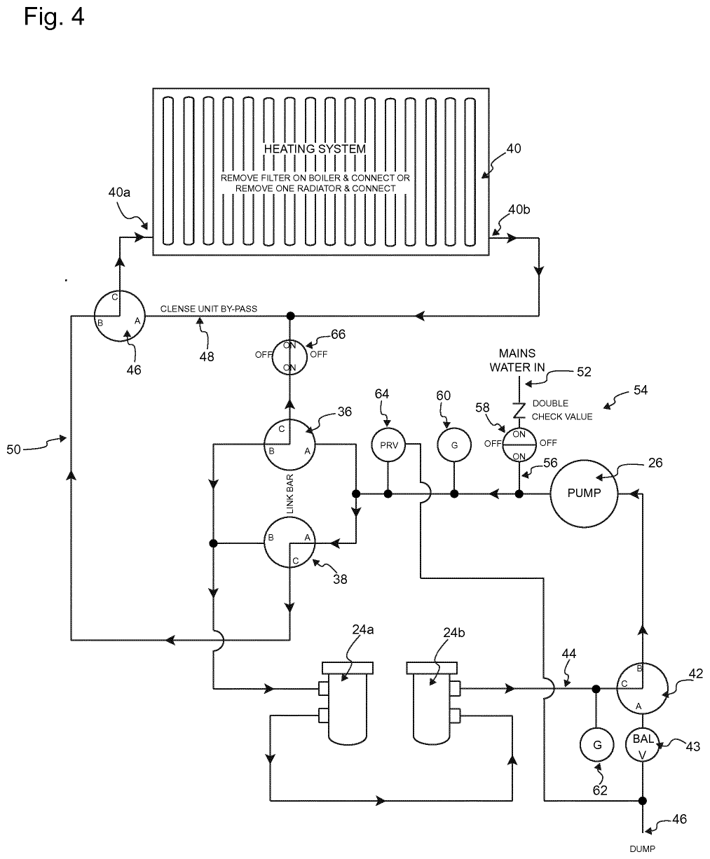

Referring now to FIG. 4, the device 10 is shown again in a flushing mode with water being circulated by the pump 26, but with the flow direction reversed through the central heating circuit 40. After filling, the water is pumped by the pump 26 to the filter arrangement though ports A-C on valve 38, through ports B-C on valve 46 to connection 40a on the central heating circuit 40. Once the water has passed through the central heating circuit 40 to be flushed, the water passes through connection 40b and passes back to the valve arrangement, where it passes through ports C-B of valve 36. This directs the water to the filters 24a, 24b, where the water is magnetically filtered. After filtering, the water is passed through ports C-B of valve 42 and is directed back to the pump 26.

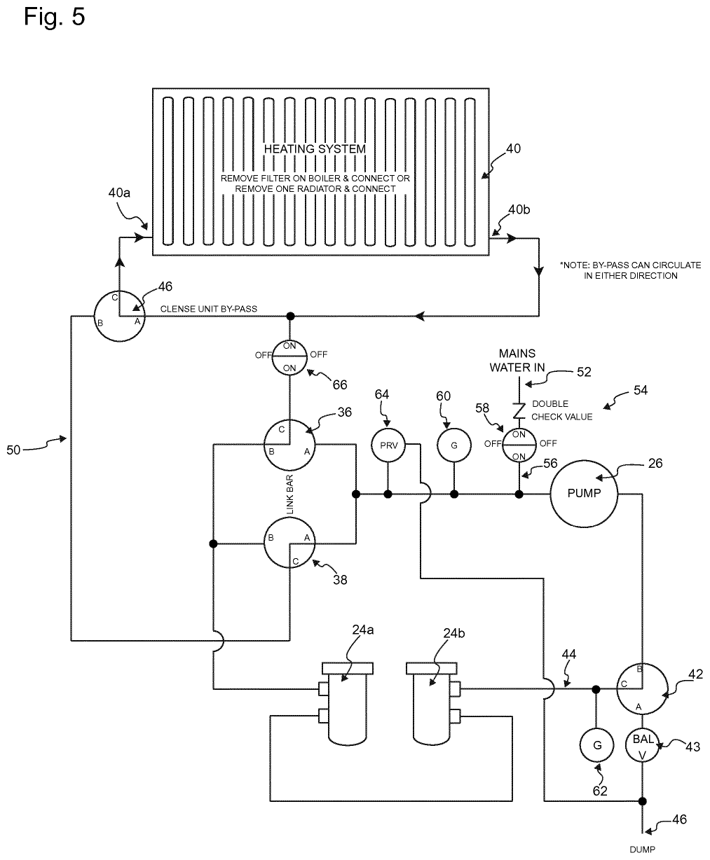

In FIG. 5, the pump 26 and filters 24a, 24b of the device 10 are bypassed for testing. In this mode, the water is routed from connection 40b straight back to connection 40a, through ports A-C of valve 46. The shut off valve 66 is closed to isolate the rest of the flushing machine circuit. It should be noted that flow can be in either direction through the central heating circuit 40 and is substantially unrestricted through the device 10.

It will be noted that valve 46 is always configured with ports B-C, C-B connected when the device 10 is in operation, except when the bypass mode is in use. In other words, valve 46 is operated to engage bypass mode.

Ports C-B of valve 42 are connected when in circulation mode, but ports C-A of valve 42 are connected for dumping mode. Consequently, valve 42 needs to be operated to change between circulation and dumping mode.

In one embodiment the valves are manual. In another embodiment, the valves are electro-mechanical and electronically controlled.

To change water flow direction through connections 40a, 40b, both 2-way valves 36, 38 need to be operated. In one direction ports A-C of valve 36 and B-C of valve 38 are connected and in the other direction ports B-C of valve 36 and A-C of valve 38 are connected. No other connection arrangement is possible. If the 2-way valves 36, 38 are both operated simultaneously, then, flow through the connected central heating circuit 40 can be changed in direction. This can be automatic, enabling an automatic cleaning mode, in which the direction of flow is changed over time.

When in operation, particularly when in circulation mode, it is important that the filters 24a, 24b remain effective to prevent magnetite from passing through the pump 26. To facilitate this, a sensor, for example, a magnetometer can be fitted to each filter casing, as described in the applicant's co-pending application GB 1606795.1. Alternatively, and in a preferred embodiment, a sensor, for example a magnetometer, is only fitted to the first filter 24a before the pump 26. This provides an early warning that the filtering capacity is reached, because the second filter 24b in the series will continue to filter after the first filter reaches capacity. Put another way, the second filter in the series still collects magnetite when the water flowrate is decreasing, prior to becoming static as the filters clog up. Therefore by using only one sensor on the first filter 24a in the direction of flow towards the pump 26, there is less risk of exposing the pump to magnetite in the flow.

When the magnetometer detects that the filter needs cleaning, circulation should be stopped and the filters cleaned. In one arrangement, the filter pump is electronically controlled. When the magnetometer detects that the or each filter 24a, 24b is full of magnetite and requires cleaning, then the pump is automatically shut down until the magnetometer gives a “clean” reading.

A control panel, indicated schematically at 68, can be used to control the machine 10, when the valves are all fully automated. A display screen 70 displays, for example, pressure readings at the gauges 60, 62; the level of magnetite detected in the filters 24a, 24b; the operable state of the valves 36, 38, ie flow direction; and the operable state of the valves 42, 46, for dumping and bypass modes. The state of the control valves 58, 66 can also be controlled and displayed. The device 10 can be switched between modes automatically, by operating switches or press-buttons 72 on the controller 68.

The control panel 68 can also be connected to a remote device, for example, a Bluetooth device, such as a tablet or mobile telephone, and operated through an application on that device. In this way, the machine 10 can be operated remotely, whilst for example, checking a system for leaks.

The embodiments described above are provided by way of example only, and various changes and modifications will be apparent to persons skilled in the art without departing from the scope of the present invention as defined by the appended claims.

1. A flushing machine comprising at least one magnetic filter, a pump, and first and second connections for connecting to a central heating circuit to be flushed, and a valve means enabling a flow direction through the first and second connections to be changed.

2. The flushing machine according to claim 1, in which the magnetic filter, the pump and the valve means are connected to direct a flow through the filter before the pump, irrespective of the direction of the flow through the first and second connections.

3. The flushing machine according to claim 1, in which the valve means includes at least two 2-way valves.

4. The flushing machine according to claim 1, in which there are two magnetic filters connected in series.

5. The flushing machine according to claim 1, in which a third valve and a connecting pipe are provided enabling the first and second connections to be connected together.

6. The flushing machine according to claim 5, in which a shutoff valve is provided to isolate the at least one magnetic filter and the pump in a bypass mode.

7. The flushing machine according to claim 1, in which a fourth valve is provided for diverting an outlet flow from the at least one magnetic filter to a drain outlet.

8. The flushing machine according to claim 1, in which a mains water connection is provided for connecting to a mains water supply.

9. The flushing machine according to claim 8, in which a double check valve is positioned adjacent the mains water connection for preventing backflow into the mains water supply.

10. The flushing machine according to claim 1, in which the or each valve means is electrically operated.

11. The flushing machine according to claim 10, in which a control unit is provided for operation of the valve means.

12. The flushing machine according to claim 11, in which the valve means is operated automatically on selection of a mode of operation.

13. The flushing machine according to claim 12, in which the flow direction through the first and second connections is changed automatically during a power flush.

14. The flushing machine according to claim 12, in which a magnetite sensor is provided on the or each magnetic filter.

15. The flushing machine according to claim 14, in which there are two magnetic filters connected in series and in which a magnetite sensor is provided on only the first filter in a flow path before the pump.

16. The flushing machine according to claim 14, in which the control unit is configured to automatically shut down the pump to stop power flushing when the magnetite sensor detects a predetermined level of magnetite in the filter.

17. The flushing machine according to claim 1, in which the flushing machine does not include a holding tank for flushing water.

18. A method of flushing using a flushing machine according to claim 1, comprising passing flushing water through a central heating circuit in one direction and then in another direction.

19. A flushing machine according to claim 1, in which the valve means includes at least two 2-way valves, in which a third valve and a connecting pipe are provided enabling the first and second connections to be connected together, in which a shutoff valve is provided to isolate the at least one magnetic filter and the pump in a bypass mode, in which a fourth valve is provided for diverting an outlet flow from the at least one magnetic filter to a drain outlet, and in which a double check valve is positioned adjacent the mains water connection for preventing backflow into the mains water supply, in which the operation of each of the two 2-way valves, the third valve, the shut off valve, the fourth valve, and the double check valve are electrically operated.

20. A flushing machine according to claim 19, in which a control unit is provided for operation of each of the two 2-way valves, the third valve, the shut off valve, the fourth valve, and the double check valve.
